(19) United States
(12) Patent Application Publication
(10) Pub. No.: US 2004/0022576 A1
(43) Pub. Date: Feb. 5, 2004

(54) Disposable toothbrush and dentifrice combination unit

(76) Inventors: Winston Hoyle, Adelaide (AU); Debra Sue Hoyle, Adelaide (AU)

Correspondence Address: Steven W Hoyle, RMB 334 Ironbank, Adelaide South Australia, 5153, AU

(21) Appl. No.: 10/362,441

(22) PCT Filed: Sep. 26, 2001
(86) PCT No.: PCT/AU01/01203

(30) Foreign Application Priority Data
Sep. 26, 2000 (AU) PR0380

(51) Int. Cl. B43K 5/06; A46B 11/04; A47L 13/22

(52) U.S. Cl. 401/172

(57) ABSTRACT

A new, disposable toothbrush and toothpaste combination unit, that allows for dentifrice or gel to be stored internally in the entire body, neck and head of the brush for dispensing dentifrice onto the toothbrush bristles via a delivery nipple by turning a knob as displayed in FIGS. 1 and 18. This is accomplished by the inventive construction, assembly order and design of the device. The device will stand up on the flat face of the knob and the device will sit on it's back due to feet located on two sides of the brush body thus stopping it from rolling onto its side when placed down after use, the devices shape is a near isosceles triangle which is an ergonomic size and shape which makes using and gripping the device easy and comfortable. The device has a flip top cap comprising of hollow cylindrical push on cover for the brush head with a plastic hinged movable flap that has a centrally located tapered shaft that inserts into the interior of the delivery nipple, thus creating an air tight seal in the dentifrice delivery nipple when moved into a closed position after each use. The device is assembled by snapping, interfacing or pushing the components together, and resulting in an assembly is easy and economic to assemble but that cannot be pulled apart easily, and increasing the devices safety and economy.

### BACKGROUND AND CROSS-REFERENCE TO RELATED APPLICATIONS

In the opinion of the inventor this device provides substantial advantages, novelty and inventive steps over prior art particularly with reference to BE 1000391, DE 3312392, U.S. Pat. No. 4,521,128, U.S. Pat. No. 5,913,632, U.S. Pat. No. 5,918,996, U.S. Pat. No. 5,842,487, U.S. Pat. No. 5,769,553, U.S. Pat. No. 5,100,252, U.S. Pat. No. 5,066,155, U.S. Pat. No. 4,291,995, U.S. Pat. No. 6,056,469, U.S. Pat. No. 6,062,233, U.S. Pat. No. 6,095,710 in a number of respects;

it is of an economic, unique and simple design, constructed with minimal assembly required, when compared to prior art,

it is disposable and is delivered to consumers fully sealed, pre-filled with dentifrice, assembled and ready for use, thus is used with ease and convenience, when compared to prior art,

provides the potential for a substantial amount of paste to last the recommended lifetime of the brush without refilling, when compared to prior art,

all parts may be manufactured out of a suitable plastic, or some other material, thus reducing costs, when compared to prior art,

Due to the inventive design the piston does not have to be wound down the length of the threaded shaft to get it into a starting position thus reducing assembly time, when compared to prior art,

The inventive design allows an assembly order such that the entire neck, head and body may be filled with dentifrice thus maximizing the devices economy, when compared to prior art,

The devices flip top cap allows the dentifrice to be sealed after each successive use, thus preventing the dentifrice from drying out or leakage, when compared to prior art.

### SUMMARY

A new, disposable toothbrush and toothpaste combination unit, that allows for dentifrice or gel to be stored internally in the entire body, neck and head of the brush for dispensing dentifrice onto the toothbrush bristles by turning a knob as displayed in FIGS. 1 and 18.

After the knob is turned, the user then simply brushes their teeth with the device and rinses off the bristles with water and replace the flip top cap (if desired) and the brush is ready for use again next time, (hereafter referred to as the device).

The inventive device is constructed so that it is delivered to the user, without any required product assembly or loading of dentifrice. It also provides a tamper proof seal for the dentifrice before use and is simple and economical to manufacture, assemble and use.

The dentifrice is extruded through a central delivery nipple, on the brush head in the middle of the bristles, by the forward action of a piston along a threaded shaft. The delivery nipple does not protrude as high as the bristles from the brush head face. This nipple is surrounded by a plurality of bristles configured so they act as a funnel to ensure the dentifrice is guided up onto the top of the brush bristles and when not in use the brush head portion is covered and dentifrice is sealed from contamination and air by a removable head cap when not in use. The dentifrice delivery nipple is sealed by the flip top cap.

The flip top cap allows the device to be sealed after each successive use thus stopping the dentifrice from drying out, maintaining a hygienic seal when not in use and preventing any accidental extrusion of paste at any time.

The hand driven actuation of a knob or end cap (hereafter referred to just as “knob”, but also meaning end cap), which also acts as a sealing cap rotates the threaded shaft. The amount of dentifrice can be observed through the indicator window. The handle or body is a near isosceles shape, with rounded edges, (hereafter referred to as just “near isosceles shape”) which is ergonomic to hold and use. At the knob end of the body this moulded plastic near isosceles shape, smoothly morphs into a circle to facilitate the knob. This portion of the body also has stabilizing feet to ensure that the brush will remain bristles up when placed on a flat surface. The knob has directional arrows on it to indicate the correct knob turning direction.

The objective of the device is to provide a ready, easy, hygienic, safe, effective, ergonomic, economical, portable and atheistically pleasing toothbrush and toothpaste combination unit.

### BRIEF DESCRIPTION OF THE SEVERAL VIEWS OF THE DRAWINGS

To aid understanding the follow discourse will explain the individual figures that are used in my detailed description. I now refer to FIG. 1 through to FIG. 19, by complete figure references, which show the inventive device, the claims or principals contained and embodied therein.

The exterior of the device is displayed in FIG. 1, in angled side views and the bristles, body, knob, directional arrows, delivery nipple, head, neck and mating flange can be seen.

FIG. 2 shows the device exterior from a top, rear, side and front view. The delivery nipple position is noted and bristle configuration can be observed.

FIG. 3 shows the device with an exploded view of the rear assembly of the device. Here the threaded shaft, piston, knob, tapered flange, lip and seat are identified.

FIG. 4 shows the interior view regarding the order of assembly, on how the piston, threaded shaft (male) and knob (female) may be assembled and also identifies tapered male and female octagonal, the tapered threaded lead in, the internal piston thread, the piston flange and the locating lug or lip.

FIG. 5 shows various cross-sectional's of the assembled device and identifies the dentifrice reservoir and identifies the reservoir, shaft, piston, knob and cross sectional end view.

FIG. 6 shows a close up of the brush head and identifies the bristle configuration. A cross sectional of the brush head identifying the delivery nipple, the brush head portion of the dentifrice reservoir, the bristles and the extent to which the delivery nipple protrudes past the brush head face is also shown.

FIG. 7 shows a close up of the knob, piston, and threaded shaft assembled into the body in the starting position. The fastener, piston, shaft, tapered octagonal interface and knob are identified. Noteworthy here is the inventive fastening mechanism.

FIG. 8 shows various views of the knob and the knob interior and exteriors are identified. Also shown are the end and a cross sectional view of the knob.

FIG. 9 displays the fully assembled device, complete with the brush head cap. For orientations purposes the knob, brush head cover (flip top cap) and body are identified.

FIG. 10 shows a close up view of the brush stabilizing feet and displays an angled view of the external shape or profile of the invention. The brush body, cap, body end, feet and external profile are noted.

The following diagrams explain the flip top cap, which seals the delivery nipple.

FIG. 11 shows the exterior of the device, in angled side views and the hinge, ventilation holes, finger undercut and internal lip can be seen.

FIG. 12 shows the flip top cap exterior from a top, side, end and cross sectional (A-A) view. The sealing mechanism and finger-undercut positions are noted.

FIG. 13 shows the flip top cap assembled into or onto the flip top cap. Top, side and end views are noted.

FIG. 14 shows the flip top cap unassembled and in the flipped open position. The guards, lid, latch, body, lip edges and finger undercut can be seen.

FIG. 15 shows the flip top cap unassembled and in the flipped open position from a top, side, end and cross sectional view. The sealing mechanism and ventilation holes are noted.

FIG. 16 shows the flip top cap assembled onto the brush and in the flipped open position from a top, side, and cross sectional end view. Here the toothbrush head of the device is noted.

FIG. 17 shows a close up of the head section of FIG. 16. The flip top cap can be seen assembled onto the brush and in the flipped open position from a top and side view. Here the hinge and catch are noted.

FIG. 18 shows the flip top cap assembled onto the device in a side on, cross-sectional view, the device is shown here without bristles.

FIG. 19 shows a close up of the head section of FIG. 18. The flip top cap can be seen assembled onto the brush. Here the lid lip, sealing mechanism and ribs can be seen.

### DETAILED DESCRIPTION OF THE INVENTION

The following statement is a full description of this invention:

This invention relates to the combining of a toothbrush and toothpaste into one combined and compact unit. This device will address the need for a convenient method of brushing your teeth that is portable and compact, particularly while away from home, but can be used as an everyday brush. This device also eliminates the need for toothpaste tubes, toothbrush and toothpaste holders or containers.

A typical embodiment of this disposable toothbrush and dentifrice combination unit is displayed and comprising of and by reference, to numerical FIGS. 1 thought to 19 (identified as figure) and the individual numerical item numbers (identified as ref. and identifying individual parts within a figure), contained herein and the device is described as follows:

A toothbrush, whose entire internal head, neck and body cavity are able to be loaded with toothpaste, dentifrice or gel for cleaning teeth. Consisting of a handle or body which is a near isosceles shape, with rounded edges (refer FIGS. 1 & 2). It has a storage section with a surrounding wall section to define the storage chamber or reservoir, within which dentifrice is contained. The body is open at one end to receive the knob. The brush delivery nipple, head, neck, body and knob receiver may be moulded in one entire section.

A toothbrush head section that has a plurality of bristles that extend from the brush head. The head section also has a dentifrice storage section, with a surrounding wall section that defines the storage chamber. This section is a seamless continuation of the body's dentifrice reservoir.

The brush head may be a continuation of the above-mentioned brush body or detachable, the head section internally and externally seamlessly morphs to the body section in one continuous piece.

The preferred embodiment for sealing the delivery nipple is via the flip top cap and is described as follows:

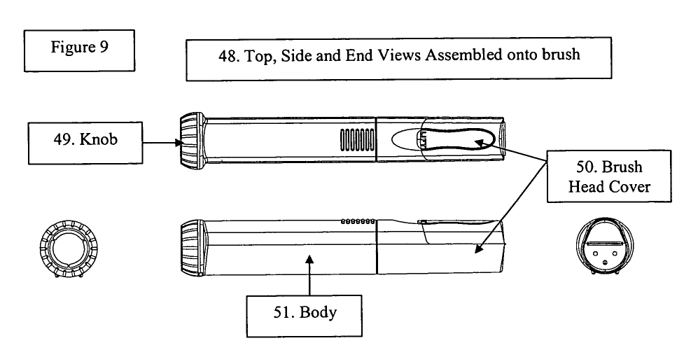

A typical embodiment of the flip top cap is displayed and comprising of and by reference, to numerical FIGS. 9 thought to 19 (identified as figure) and the individual numerical item numbers (identified as ref. and identifying individual parts within a figure), contained therein and the device is described as follows:

A flip top cap, which is used to cover the head of a toothbrush and seal in the dentifrice contained therein. Consisting of a body (ref 75. & 93.) that fits onto the hand of the brush and a lid (ref 68., 76., 81. & 92.)

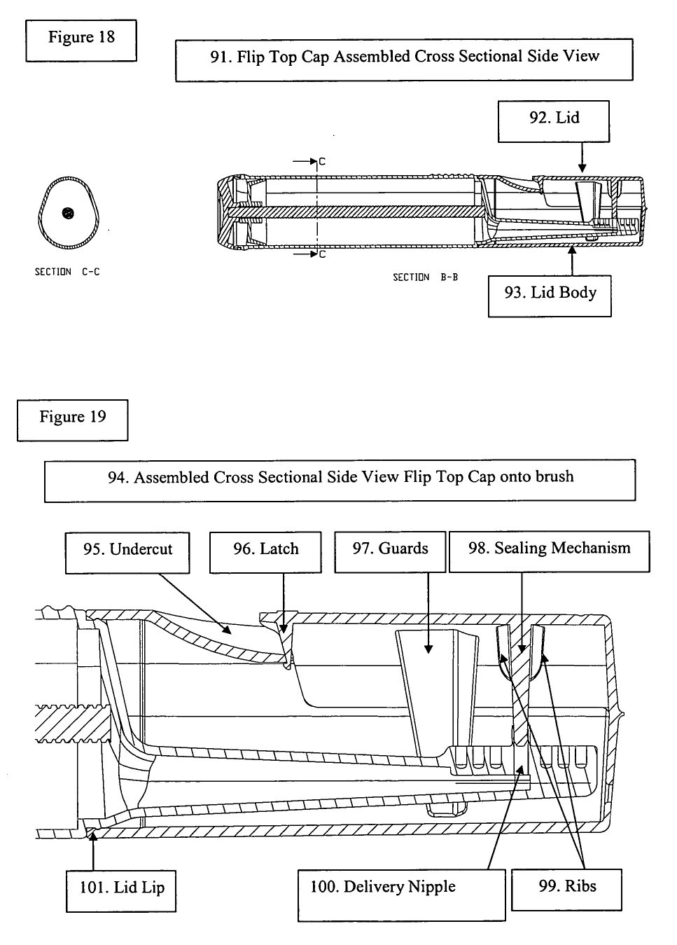

The flip top cap is secured in place by a lip, groove and stop guide mechanism on the exterior of the brush body near the neck and a lip and stop guide on the internal face of the leading edge of the cap (ref 59.). The internal lip and stop guide of the head cap exists around the entire interior circumference of the head cap. The groove and stop guide, exist around the entire exterior circumference of the body. The installed brush head cap (the flip top cap) is displayed in FIGS. 9, 13, 18 and 19. In FIG. 19 the lid lip mechanism can be seen (ref 101.).

The lid (ref 68.) is held onto the body by way of a hinge (ref 57. & 87.) which allows the lid to move up or down. During the lid closing movement, the lid edges are guided into position by mating with the lip groove edges (ref 72.) on the body. This ensures proper alignment and sealing.

In the closed position the lid is held in position by a latch (ref 69. & 96.) located on the lid. The latch is flexible and has a hook on the end, which interfaces with the end of the finger undercut (ref 95.) portion of the body thus securing it in place, but still allowing the lid to be flipped open as desired by placing your finger into the finger undercut (ref 95.) and lifting upwards.

The lid also has a sealing mechanism (ref 63., 78., 84., 90., & 98.) which seals the dentifrice. This is achieved by placing the sealing mechanism into the internal core of the delivery nipple, guided into place by the delivery nipple tulip (ref 33.). The sealing mechanism has a circular protrusion, which interfaces with the internal wall section of the delivery nipple creating a seal. The sealing mechanism is reinforced by ribs (ref 99.) around its base.

The flip top cap is installed onto the brush by the following steps. The cap in the flipped open position is put onto the body of the brush so that the lid lip (ref 101.) interfaces at its seated position. The lid portion of the flip top cap is then lowered into position so that the latch mechanism (ref 96.) interfaces with the end portion of the undercut (ref 95.). In this closed position the sealing mechanism is interfacing with the internal wall of the delivery nipple, thus creating a seal. The device is removed in by flipping the lid (ref 68.) open and then pulling the flip top cap it off the brush's body.

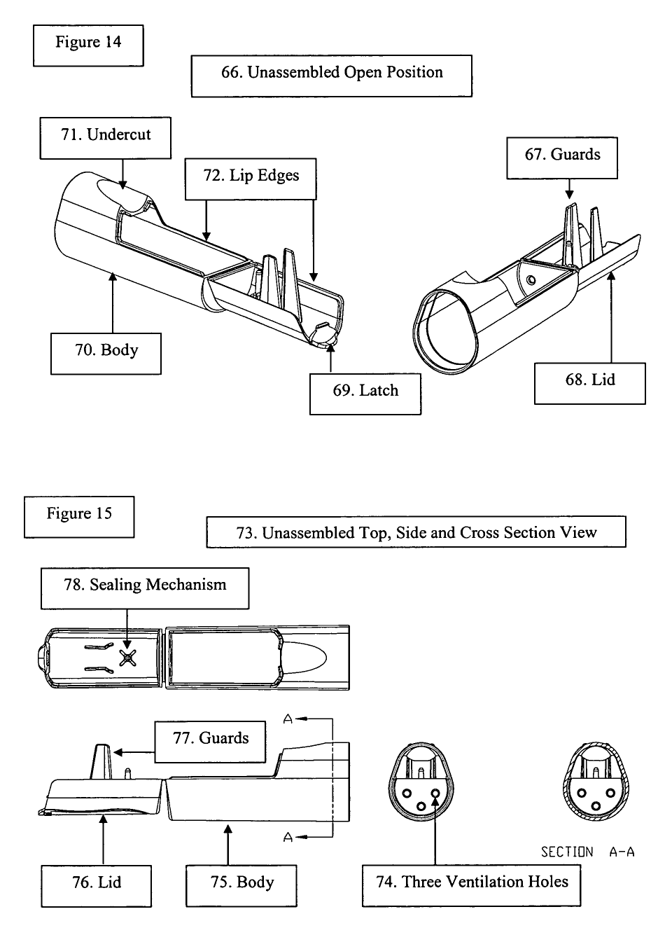

The lid portion of the flip top lid also has guards (FIG. 14, ref 67.). These prevent the removal of the flip top cap from the brush without opening the lid first. This prevents the sealing mechanism from being bent by improper removal. The guards, when in place, fit around the tooth brush head of the brush.

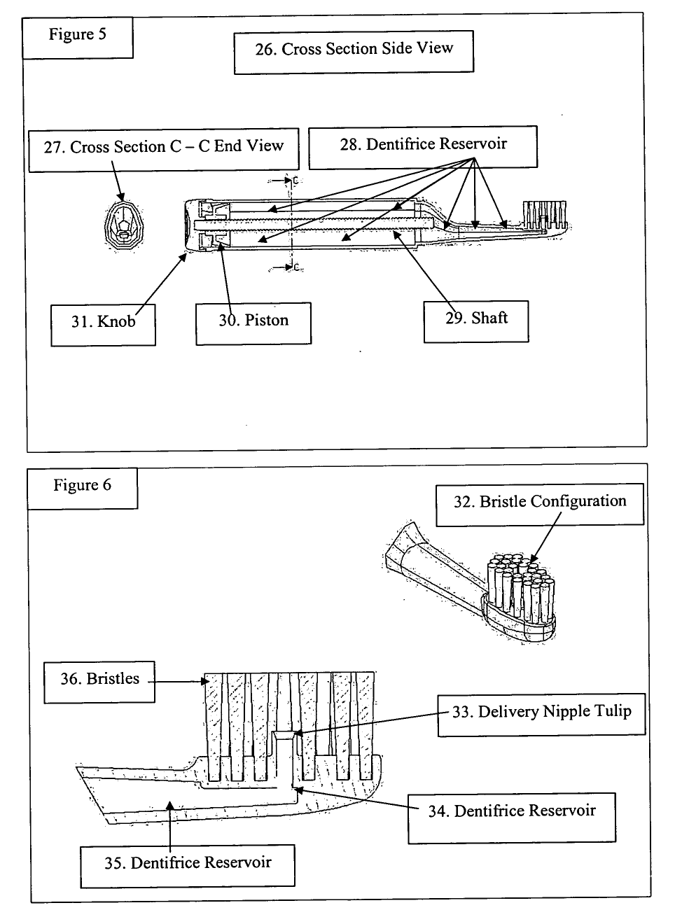

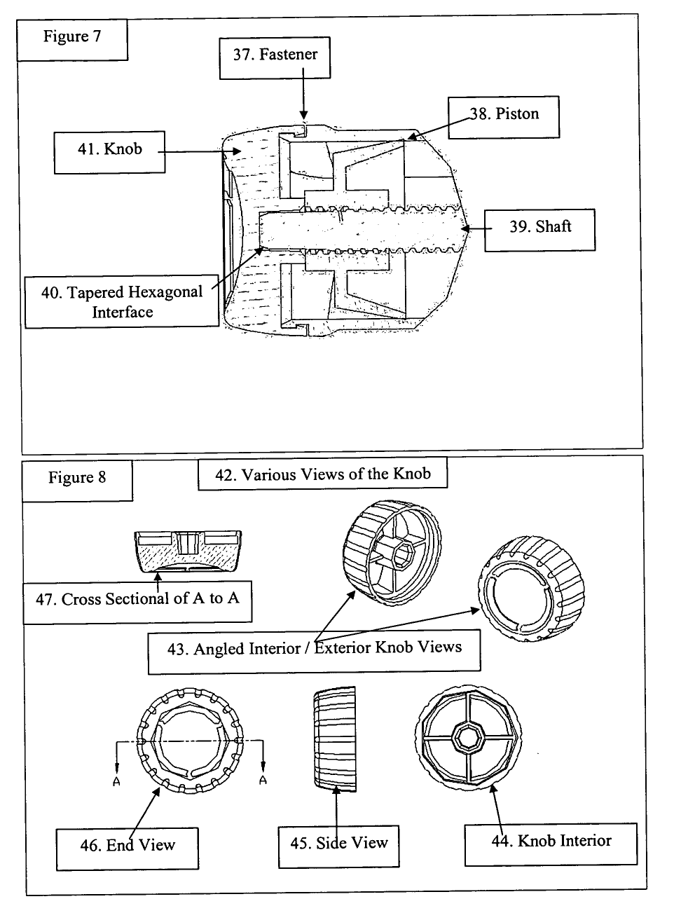

There is a round knob (ref 3. & FIG. 8) that has an interior one way locating lug and or clip fastening (ref 25. & 37. & 41.) mechanism. This mechanism enables the knob to snap onto the end of the handle thus sealing the handle end (FIG. 7), but still allowing the knob to be turned in this location. There is a threaded shaft that mate's into the knob (FIGS. 5 & 7). This occurs by way of a tapered male octagonal spigot (ref 21.) end section on the threaded shaft. This end section, by way of interference fit, couples with the female tapered octagonal cavity (ref 20. & 44.) located in the centre of the knob.

The knob (FIG. 8) is located onto the body via a one-way snap on mechanism (ref 18. & 25. & 37. & FIG. 7) contained in the exterior of the body and the interior of the knob. The knob has an interior leading edge that is an angled tapered one way lip that hooks itself into a groove or seat on the body. Just behind the interior leading edge, the knob has a square recess that sits on a mirror image protrusion existing on the brush body. The recess and lip exist around the entire interior circumference of the knob (FIG. 7 & ref 18.). The protrusion and groove exist around the entire exterior circumference of the brush body (FIGS. 7 & 8).

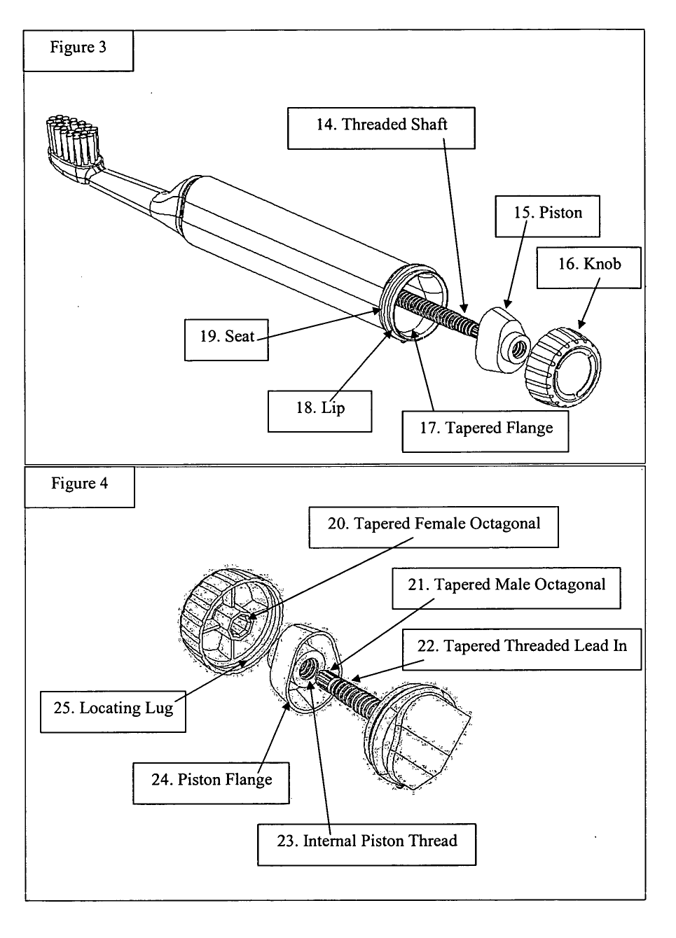

The bodies exterior end section has a square protrusion and a square groove or seat, within which the interior face of the knob's lip and recess mates with the bodies lip and groove (ref 18. & 19. and FIG. 7). This method fastens the knob onto the open end of the body (ref 37. & FIG. 3), but still allows the knob and threaded shaft to be rotated.

This rotation will cause the forward movement of the piston (ref 15.) that is engaged via its internal female thread, on the threaded shaft, to move along the threaded shaft (ref 14.). Thus, an internal piston may be moved from the knob end of the body, to the head end of the body, by the turning of the external knob.

The one-way snap on action of the fastening mechanism, discourages the knob from being pushed or pulled off. The knob exterior is of such an angle and has exterior grooves to aid gripping and turning during actuation but discourages the user from pulling the knob off (ref 16. and FIGS. 7 & 8).

The threaded shaft (ref 14. & 22. & 29. & 39.) physically communicates with the knob. This is via the threaded shaft's tapered male octagonal interference fitting spigot (ref 21. & 40.) at one end, with the knob's female tapered octagonal receiver (ref 20.), located in the centre of the knob. The other end of the threaded shaft is free floating, surrounded by dentifrice and not attached or fixed to any wall section. The threaded shaft self-centres as the piston travels down the shaft.

The threaded shaft and knob configuration is such that it allows the piston (ref 15.) to be pushed over the octagonal spigot portion of the shaft, onto the tapered threaded portion, of the threaded (ref 21. & 22.) shaft during assembly.

The knob is pushed on thereafter (FIG. 4), onto the male octagonal spigot portion of the threaded shaft. The clearance between the internal face of the knob and the piston (ref 30. & 31. & FIG. 7) is such that, generally only forward motion of the piston during initial knob rotation is allowed.

The tapered male octagonal spigot end (ref 21.) of the threaded shaft is smaller in exterior diameter than the threaded portion of same shaft (ref 14. & 22.). This allows the easy placement of the piston onto the threaded shaft during assembly, since the internal piston thread diameter (ref 23.), which is located in the piston's centre, is also larger than the tapered male octagonal spigot end of the threaded shaft. After the piston is assembled over the octagonal spigot portion of the shaft, it is then located onto the tapered starting thread (ref 22.), on the threaded shaft. This results in correct piston location, without having to wind the piston down any length of the threaded shaft to get it into the start position (FIGS. 4 & 5 & ref 38.).

There is a piston that has an internal female thread in its centre (ref 23.), which engages and moves along the threaded shaft. The piston thread is the mating thread for the threaded shaft. The piston has a specially angled flange (ref 24.) that grips the internal body reservoir wall (ref 30.). As the piston travels down through the internal brush body reservoir, the piston creates hydraulic pressure forcing the dentifrice to be extruded out of the toothbrush head's delivery nipple opening. The piston will not rotate or spin, due to the near isosceles shape, of the toothbrush handle or body. The piston shape is the same as the bodies internal near isosceles shape, with rounded edges. The piston flange angle is such so as to soak up any required draft or manufacturing variance in the interior of the body wall, and provides structural strength so the piston flange will not “lip out” or fail;

An internal tapered flange (ref 17.) is located at the internal face of the open portion of the toothbrush body end where the knob clips on. The flange morphs smoothly from a round shape to accommodate the knob, to the main bodies near isosceles shape; thus both internal shapes are accommodated seamlessly in one continuous piece (FIGS. 1 & 2 & 3 & 9). This internal tapered flange allows the piston to be guided into the correct position during assembly and initial knob actuation. The circular brush body end portion is larger in external and internal diameter than the near isosceles shape portion of the brush body. This size difference provides clearance for the piston to be put in place, onto the internal tapered flange and accommodates the knob.

During the assembly process, the knob, piston and threaded shaft are assembled together into one combination unit (FIGS. 3 & 4 & 5 & 7). This knob, piston and threaded shaft unit are installed into the open end of the brush body cavity (FIGS. 3 & 5) and fastened by the above-mentioned one-way locking mechanism (FIG. 7). The brush reservoir is filled with dentifrice (ref 28.) just before the knob, piston and threaded shaft unit is installed. No dentifrice comes out of the delivery nipple (ref 33 and 100.) due to the flip top cap being in place (ref 98.).

When in this position the knob is free to rotate but will not come off the end of the brush body. This seals the open end of the brush body, but allows the forward activation of the piston. FIG. 5 shows the assembled toothbrush and toothpaste combination unit in a cross sectional view, without the head cap.

The knob (FIG. 8) is of such construction that it allows the device to stand on its knob end for display, storage or after use purposes. The knob also has directional arrows (ref 4. & FIG. 8) to designate the required direction of rotation to activate the forward motion of the piston.

The brush body at the circular end, near the mating flange (ref 8.) has small stabilising feet, located on the exterior bottom surface of the brush body. The feet enable the brush to lie on its back with bristles in the air, without the brush rolling onto its side during storage, display or after use. Thus the feet provide brush stability, while at rest.

This device has a simple and inventive assembly progression as per claim two (see FIGS. 3 & 4) due to the internal construction and design of this device. This assembly progression results in the device being entirely sealed, fully loaded with dentifrice and fully assembled ready for use in a simple manner.

The delivery nipple is not as high as the bristles but does protrude above the brush head face section (FIGS. 6 & 12). The delivery nipple is soft and flexible, not hard and stiff to protect the user's teeth.

A toothbrush head that has pre-moulded bristle holes, which means such holes do not need to be formed by drilling to allow tufting, thus eliminating a manufacturing process. A special bristle hole configuration and layout that forms a bristle tube around the delivery nipple to guide the dentifrice upward onto the top of the bristles (ref 10. & 32.)

The installed brush head cap is displayed in FIGS. 9, 13 and 18.

An indicator window is provided on the side of the toothbrush body so one can observe the amount of dentifrice remaining, this may but put in place by moulding, translucency, printing or labelling.

All the parts of the device can be made from suitable food grade plastics or suitable substitute material thus increasing economic viability of such a device.

The claims defining the invention are as follows:

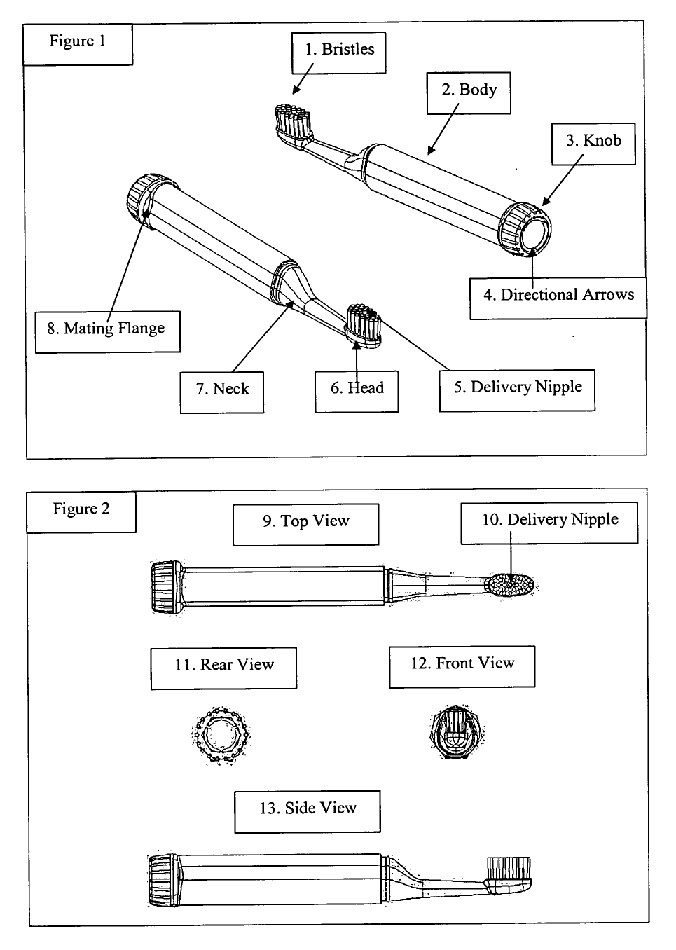

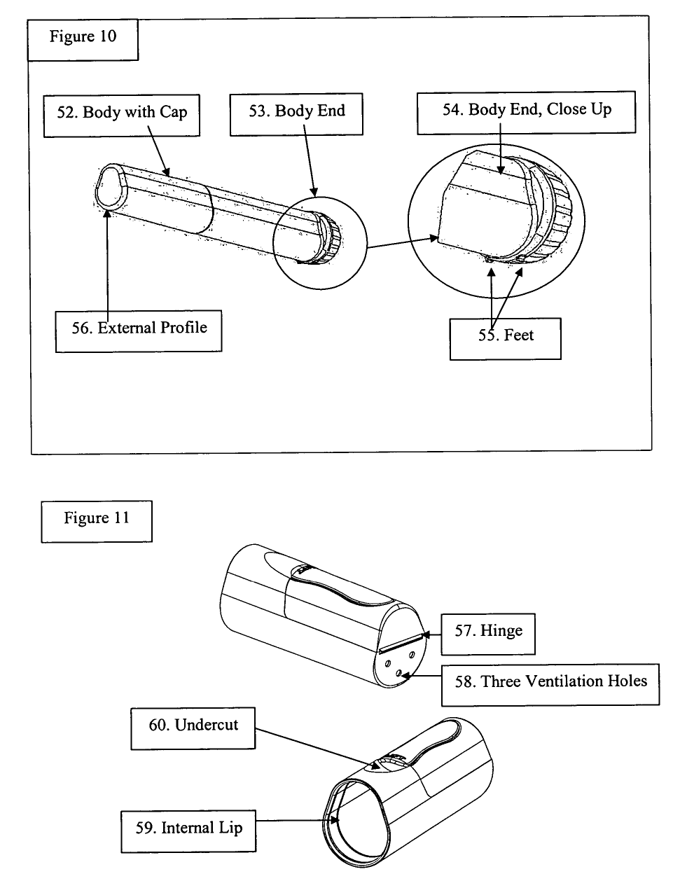

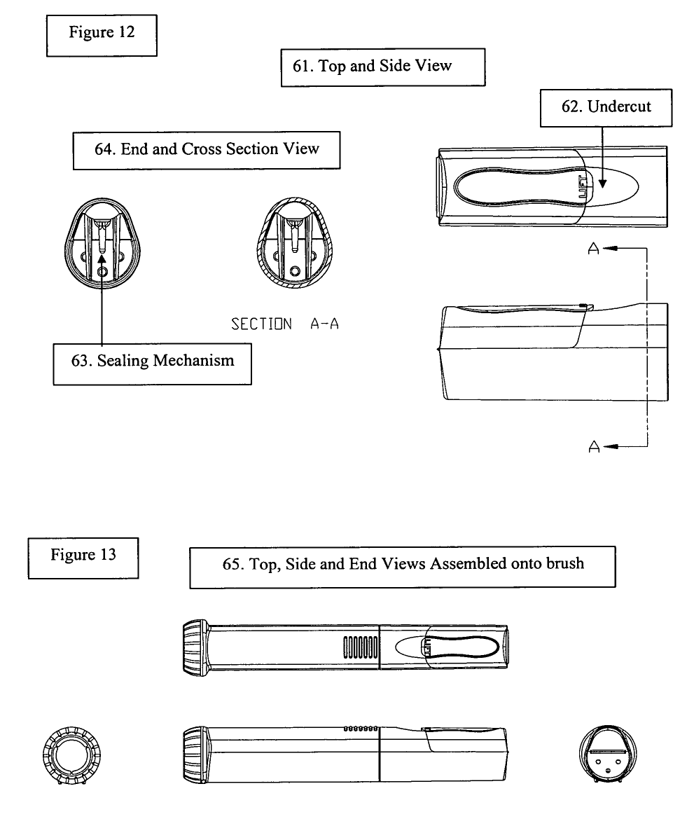

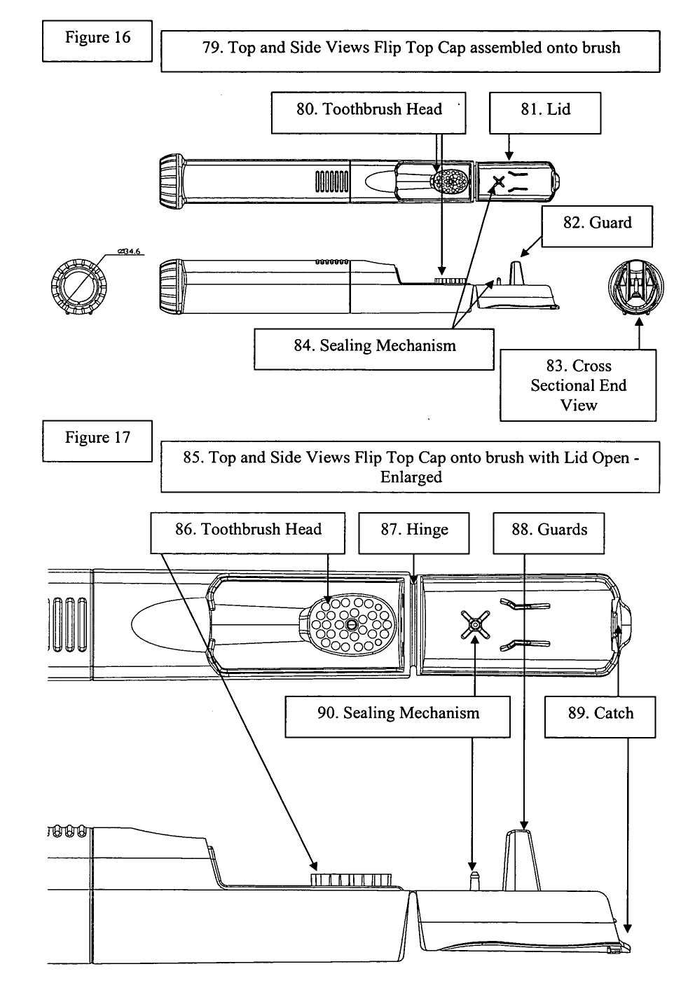

1. A Toothbrush and Dentifrice Combination device constructed entirely of a plastic or similar type material comprising of a hollow toothbrush with an interior filled throughout with dentifrice, which is extruded through one central brush head delivery nipple on to the brush head bristles, the bristle holes are moulded into the brush head and the configuration of the bristles around the delivery nipple is such that they act as a funnel to ensure the dentifrice is guided up onto the top of the brush bristles, the dentifrice is extruded by the hand actuation rotation of a knob, the knob sits in a lip and groove arrangement at the end of the brush body, the internal knob face has a centrally attached threaded shaft, the shaft has a non-round piston engaged on the thread which moves forward along the internal brush body wall by rotating the knob which rotates the threaded shaft, the piston which has leading edges, that interface with the internal bush body wall, thus displacing the dentifrice which escapes out of the delivery nipple, onto the bristles, the device will stand up on the flat face of the knob in a stable manner and the device will sit on it's back due to feet located on two sides of the brush body thus stopping it from rolling onto its side when placed down after use, the devices shape is a near isosceles triangle which is an ergonomic size and shape which makes using and gripping the device easy and comfortable, a flip top cap comprising of hollow cylindrical push on cover for the brush head with a plastic hinged movable flap that has a centrally located tapered shaft that inserts into the interior of the delivery nipple thus sealing the dentifrice delivery nipple when moved into a closed position and the flip top head cap cannot be removed without first flipping open the lid of the flip top cap due, to the tapered arms on the inside of the moveable lid that wrap around the base of the brush head, the cap is guided into the correct position onto the brush by internal grooves and mating lips on the in the inside of the cap and exterior of the brush body and the movable lid on the flip top cap is guided into the correct closed position by the internal grooves and mating lips on the inside edges of the flip top cap lid and exterior edges of the flip top cap body so that the tapered shaft that seals the dentifrice is correctly aligned for proper sealing of the delivery nipple, the tapered shaft is also and the closed position of the flip top cap lid is maintained by a flexible arm on the flip top cap lid with a lip on it's end that hooks under a wall section on the flip top cap body, the lid is opened by inserting a finger into the undercut section of the movable lid, flipping it up and then removed by pulling the flip top cap off the brush head and may be replaced in reverse order of this, the flip top cap allows the device to be sealed after each successive use thus stopping the dentifrice from drying out, maintaining a hygienic seal when not in use and preventing any accidental extrusion of paste at any time, a Disposable Toothbrush and Dentifrice Combination device substantially as herein described with reference to the accompanying drawings FIGS. 1 to 19 inclusive.

2. The Toothbrush and Dentifrice Combination device as per claim one allows dentifrice to be loaded throughout the head, neck and handle cavity thus maximising the amount of dentifrice contained within, this is accomplished by the inventive construction, assembly order and design of the device as follows; the delivery nipple is sealed via the flip top cap, the entire device is then filled with dentifrice, since the piston's female centrally threaded opening is larger than the threaded shaft's shoulder, the piston can be placed over the threaded shaft shoulder onto the tapered lead in portion of the thread on the threaded shaft, so that the shaft shoulder is then pressed (tapered interface fit held in place with small barbs) into the internal female cavity recess face of the knob, this complete sub assembly comprising of the piston, threaded shaft and knob is then placed into the internal body of the brush from the rear, the piston is guided into position by the body's tapered internal lead in and the face of the knob edge is pressed over a lip on the body to be seated into a groove on the internal face of the knob, thus sealing the entire unit and completing the assembly process.

3. A Toothbrush and Dentifrice Combination device as per claim one which can be assembled by snapping, interfacing or pushing the components together, no other means of affixing the parts together for assembly is required, thus reducing the requirement for human intervention or specialised equipment during assembly and resulting in an assembly that cannot be pulled apart easily thus increasing the devices safety and economy.

4. A Toothbrush and Dentifrice Combination device as per claim one which has a unique shaped piston that will not rotate internally, thus removing the need for an internal piston guide to stop the piston from rotating instead of moving forward.

5. A Toothbrush and Dentifrice Combination device as per claim with a configuration of bristles that act as a funnel to guide the dentifrice up onto the bristles see ref 32. and FIG. 17.
